(19) United States
(12) Patent Application Publication
(10) Pub. No.: US 2022/0034989 A1
(43) Pub. Date: Feb. 3, 2022

(54) POSITION ESTIMATION DEVICE, POSITION ESTIMATION SYSTEM, POSITION ESTIMATION METHOD, AND RECORDING MEDIUM

(71) Applicant: NEC Corporation, Minato-ku, Tokyo (JP)

(72) Inventor: Masaki KITSUNEZUKA, Tokyo (JP)

(73) Assignee: NEC Corporation, Minato-ku, Tokyo (JP)

(21) Appl. No.: 17/276,928

(22) PCT Filed: Sep. 24, 2019
(86) PCT No.: PCT/JP2019/037165

§ 371 Date: Mar. 17, 2021

(30) Foreign Application Priority Data
Sep. 27, 2018 (JP) 2018-182338

(51) Int. Cl. G01S 5/00; H04W 4/02; H04W 4/029

(52) U.S. Cl. CPC G01S 5/0063; H04W 4/029; H04W 4/027

(57) ABSTRACT

A position estimation device includes a position estimation unit that estimates a position of a wireless terminal device based on a radio wave reception range of the base station device that has transmitted a response signal in response to a signal from the wireless terminal device.

### TECHNICAL FIELD

The present invention relates to a position estimation device, a position estimation system, a position estimation method, and a recording medium.

### BACKGROUND ART

A technique has been proposed that estimates the position of another communication device on the basis of the communication area of a communication device.

For example, the position estimation device described in Patent Document 1 is attached to a vehicle, and acquires information from a first peripheral vehicle located inside a first communication area, inside which direct inter-vehicle communication is possible from the host vehicle. The position estimation device acquires area information relating to a second communication area, inside which direct inter-vehicle communication is possible from the first peripheral vehicle, and identification information of a second peripheral vehicle located inside the second communication area. Further, the position estimation device calculates a region inside the second communication area and outside the first communication area as the region in which the second peripheral vehicle may be located.

### PRIOR ART DOCUMENTS

### Patent Document

[Patent Document 1] Japanese Unexamined Patent Application, First Publication No. 2010-68208

### SUMMARY OF THE INVENTION

### Problem to be Solved by the Invention

The position estimation device described in Patent Document 1 estimates the position of the second peripheral vehicle using communication area information of the first peripheral vehicle, which is capable of directly communicating with the position estimation device itself.

On the other hand, in the case of a base station device communicating with a wireless terminal device, the position estimation device, which is a third party, usually does not have permission to directly communicate with the base station device. Therefore, information cannot be actively acquired from the base station device.

If the position of a wireless terminal device can be estimated by utilizing information from devices with which direct communication is not possible, the number of devices provided for position estimation can be made relatively small. Therefore, the equipment costs required for position estimation can be reduced.

An example object of the present invention is to provide a position estimation device, a position estimation system, a position estimation method, and a recording medium that are capable of solving the above problem.

### Means for Solving the Problem

According to a first example aspect of the present invention, a position estimation device includes: a position estimation unit that estimates a position of a wireless terminal device based on a radio wave reception range of the base station device that has transmitted a response signal in response to a signal from the wireless terminal device.

According to a second example aspect of the present invention, a position estimation system includes a radio wave sensor device and a position estimation device. The radio wave sensor device notifies the position estimation device of a reception status relating to reception by the radio wave sensor device, of a response signal transmitted by a base station device in response to reception of a signal from a wireless terminal device. The position estimation device includes a position estimation unit that estimates a position of the wireless terminal device based on the reception status and a radio wave reception range of the base station device.

According to a third example aspect of the present invention, a position estimation method includes: estimating a position of a wireless terminal device based on a radio wave reception range of a base station device that has transmitted a response signal in response to a signal from the wireless terminal device.

According to a fourth example aspect of the present invention, a recording medium that stores a program for causing a computer to execute: estimating a position of a wireless terminal device based on a radio wave reception range of a base station device that has transmitted a response signal in response to a signal from the wireless terminal device.

### Effect of the Invention

According to an example embodiment of the present invention, the position of a wireless terminal device can be estimated by using information from a device with which direct communication is not possible.

### BRIEF DESCRIPTION OF THE DRAWINGS

FIG. 1 is a schematic configuration diagram showing a device configuration example of a position estimation system according to an example embodiment.

FIG. 2 is a diagram showing an arrangement example of radio wave sensor devices according to the example embodiment.

FIG. 3 is a diagram showing an example of communication between a wireless terminal device and a base station device.

FIG. 4 is a schematic block diagram showing an example of a functional configuration of the radio wave sensor device according to the example embodiment.

FIG. 5 is a schematic block diagram showing an example of a functional configuration of a position estimation device according to the example embodiment.

FIG. 6 is a functional block diagram showing in more detail an example of a functional configuration of the position estimation device according to the example embodiment.

FIG. 7 is a diagram showing a first example of position estimation of a wireless terminal device by the position estimation device according to the example embodiment.

FIG. 8 is a diagram showing a second example of position estimation of a wireless terminal device by the position estimation device according to the example embodiment.

FIG. 9 is a diagram showing a third example of position estimation of a wireless terminal device by the position estimation device according to the example embodiment.

FIG. 10 is a diagram showing an example of detection of a radio wave reception range of a base station device by a reception range detection unit according to the example embodiment.

FIG. 11 is a diagram showing an example of a radio wave reception range having a probability gradient according to the example embodiment.

FIG. 12 is a flowchart showing an example of a processing procedure by which the position estimation device according to the example embodiment estimates the position of a wireless terminal device.

FIG. 13 is a diagram showing an example of a configuration of a position estimation device according to an example embodiment.

FIG. 14 is a diagram showing an example of a configuration of a position estimation system according to an example embodiment.

### EXAMPLE EMBODIMENT

Hereunder, an example embodiment of the present invention will be described. However, the following example embodiment does not limit the invention according to the claims. Furthermore, not all combinations of features described in the example embodiment may not be essential to the solution means of the invention.

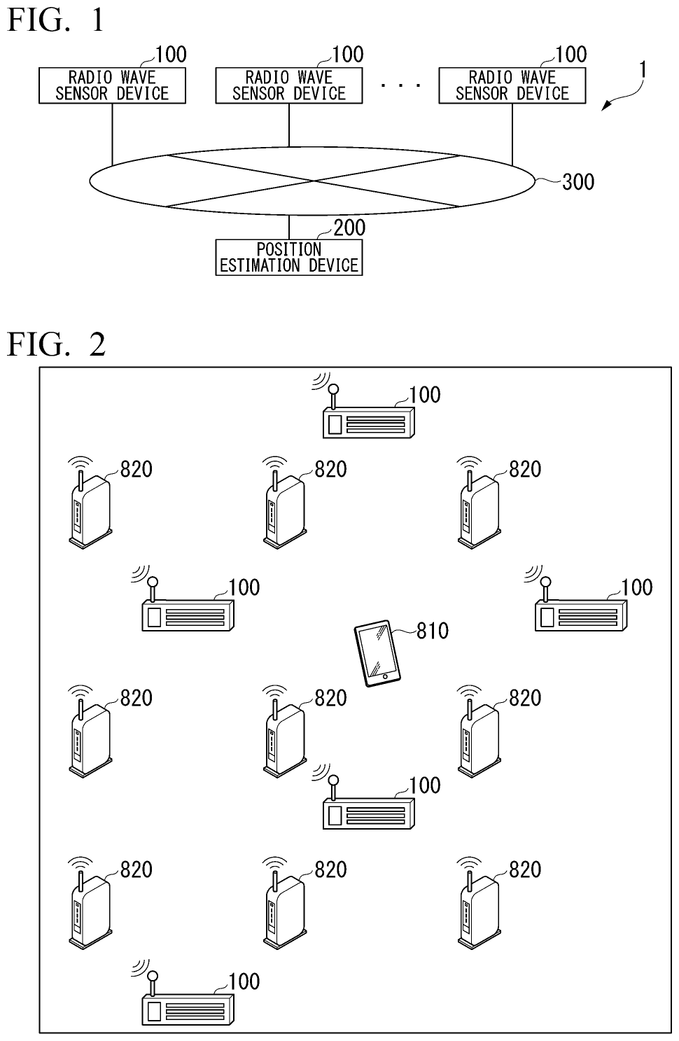

FIG. 1 is a schematic configuration diagram showing a device configuration example of a position estimation system 1 according to an example embodiment. In the configuration shown in FIG. 1, the position estimation system 1 includes radio wave sensor devices 100, a position estimation device 200, and a communication network 300.

The position estimation system 1 estimates the position of a wireless terminal device. Specifically, the position estimation system 1 receives a wireless signal transmitted by a base station device to a wireless terminal device, at the radio wave sensor devices 100, and estimates the position of the wireless terminal device on the basis of the received wireless signal. The base station device referred to here is a device which is capable of directly communicating with wireless terminal devices.

The position estimation system 1 can be used for various purposes such as collecting marketing information, investigating traffic, or monitoring suspicious persons.

For example, according to the position estimation system 1, it is possible to recognize the types of movements made by wireless terminal devices (such as portable terminal devices, mobile terminals, mobile phones, smartphones, mobile computers, and their users) inside a store or inside a shopping mall, and how long the devices have spent in each location. Furthermore, according to the position estimation system 1, it is possible to recognize the movement of people in a public facility such as a station building, or the movement of people or vehicles in a wider area such as a city. Because the position estimation system 1 is capable of recognizing the movement of people and vehicles, it is possible to monitor whether or not there are people or vehicles exhibiting suspicious behavior. In addition, the position estimation system 1 can be used to track the movement of suspicious persons or suspicious vehicles.

In the position estimation system 1, wireless terminal devices can be tracked in time series. On the other hand, the users of the wireless terminal devices cannot be identified using only the information used by the position estimation system 1. Therefore, according to the position estimation system 1, the necessary information can be collected while maintaining the anonymity of the information.

FIG. 2 is a diagram showing an arrangement example of the radio wave sensor devices 100. In the example of FIG. 2, five radio wave sensor devices 100, one wireless terminal device 810, and nine base station devices 820 are shown.

However, the number of radio wave sensor devices 100 included in the position estimation system 1 may be any number as long as it is one or more. The arrangement of the radio wave sensor devices 100 is not limited to a specific arrangement. Any arrangement can be employed as long as the arrangement enables wireless signals from the base station devices 820 to be received.

The number of base station devices 820 that are capable of receiving wireless signals from the radio wave sensor devices 100 may be any number as long as it is one or more. The greater the number of base station devices 820 that are capable of receiving wireless signals from the radio wave sensor devices 100, the larger the target area in which the position of the wireless terminal device 810 can be estimated, or the more the estimated position of the wireless terminal device 810 can be narrowed down. Alternatively, both of these effects can be obtained.

The arrangement of the base station devices 820 is not limited to a specific arrangement.

The wireless terminal device 810 is a portable device such as a smartphone or a mobile phone device. Therefore, the number of wireless terminal devices 810 located within an area capable of communicating with a certain base station device 820 changes with time. As long as the wireless terminal device 810 serving as the communication partner can be distinguished by a wireless signal transmitted by the base station device 820, a plurality of wireless terminal devices 810 may be located within an area capable of communicating with the base station device 820 at the same time.

Hereunder, a case where the base station devices 820 are access point devices used in a wireless LAN will be described as an example. For example, the base station devices 820 are arranged without blind spots in an underground mall, and the position estimation system 1 acquires wireless signals from each of the base station devices 820. As a result, the position estimation system 1 is capable of estimating the position of a wireless terminal device 810 irrespective of the location of the wireless terminal device 810 in the underground mall.

However, the base station devices 820 are not limited to a specific type of device as long as they are capable of communicating with the wireless terminal device 810. For example, in addition to access point devices, the base station devices 820 may be macrocell base station devices, microcell base station devices, small cell base station devices, or femtocell base station devices. Furthermore, the base station devices 820 may include both macrocell base station devices and femtocell base station devices, such that the size of the area in which communication is possible (in particular, the radio wave reception range) is different depending on the base station device 820.

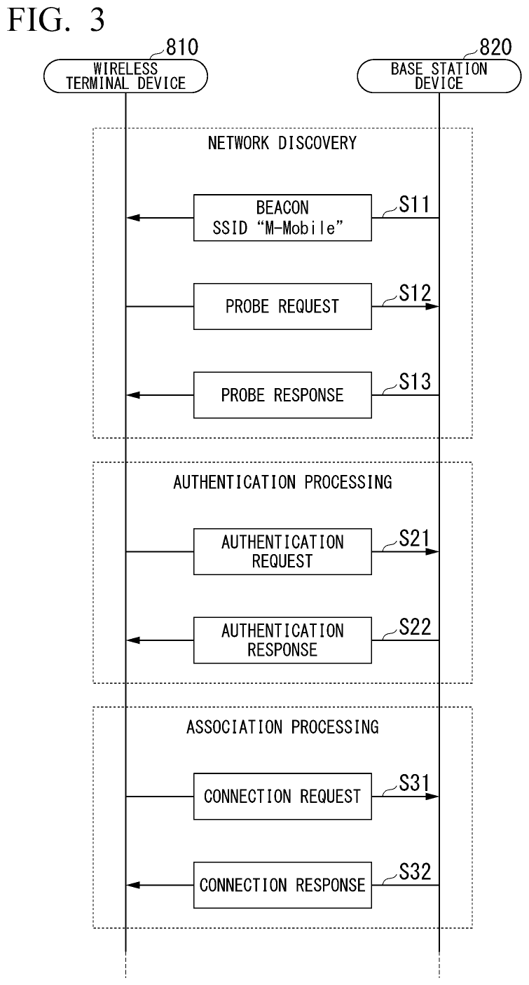

FIG. 3 is a diagram showing an example of communication between a wireless terminal device 810 and a base station device 820.

In the example of FIG. 3, the base station device 820 broadcasts a beacon containing an SSID (Service Set Identifier) “M-Mobile” for notifying an unspecified number of wireless terminal devices 810 of the presence of the base station device 820 (sequence S11). M-Mobile is the identification information of the base station device 820.

When a wireless terminal device 810 that wants to communicatively connect to the base station device 820 is located inside the communication area of the base station device 820, the wireless terminal device 810 transmits a probe request addressed to the base station device 820 (sequence S12). The wireless terminal device 810 transmits a probe request including the identification information of the wireless terminal device 810 itself, and the identification information of the transmission destination base station device 820.

The radio wave sensor device 100 of the position estimation system 1 is assumed to be capable of receiving a wireless signal, referring to the identification information included in the wireless signal, and determining the identity of the wireless terminal device 810 and the identity of the base station device 820. That is to say, the radio wave sensor device 100 of the position estimation system 1 is capable of determining whether or not the wireless terminal devices 810 indicated by two radio waves (for example, a beacon and a probe request) are the same wireless terminal device 810, and whether or not the base station devices 820 indicated by two radio waves are the same base station device 820.

Here, a MAC address (Media Access Control Address) may be used as the identification information. However, the identification information is not limited to a MAC address.

When the base station device 820 receives the probe request from the wireless terminal device 810, it transmits (replies with) a probe response to the wireless terminal device 810, which is the transmission source of the probe request (sequence S13). The base station device 820 transmits a probe response including the identification information of the base station device 820 itself, and the identification information of the transmission destination wireless terminal device 810.

The processing of sequence S11 to S13 corresponds to an example of network discovery processing. As a result of this processing, the wireless terminal device 810 and the base station device 820 are able to detect each other.

Next, the wireless terminal device 810 transmits an authentication request to the base station device 820 (sequence S21). When the base station device 820 receives the authentication request, it performs authentication of the wireless terminal device 810. The base station device 820 transmits (replies with) an authentication response to the wireless terminal device 810, which is the source of the authentication request (sequence S22). In the example of FIG. 3, an example where authentication of the wireless terminal device 810 is successful is shown.

The processing of sequence S21 and S22 corresponds to an example of authentication processing.

When the wireless terminal device 810 receives a notification that the authentication was successful, it transmits a connection request (Association Request) to the base station device 820 (sequence S31). In response to the connection request from the base station device 810, the base station device 820 performs processing for obtaining a communication connection, such as registration of the wireless terminal device 810, and transmits (replies with) a connection response (Association Response) to the wireless terminal device 810, which is the source of the connection request (sequence S32).

The processing of sequence S31 and S32 corresponds to an example of association processing. A communication connection is established between the wireless terminal device 810 and the base station device 820 as a result of the processing of FIG. 3.

The position estimation system 1 estimates the position of the wireless terminal device 810 on the basis of the communication signals (wireless signals) transmitted and received between the wireless terminal device 810 and the base station device 820 as shown in the example of FIG. 3. Specifically, the position estimation device 200 of the position estimation system 1 estimates the position of the wireless terminal device 810 on the basis of wireless signals (various response signals) transmitted by the base station device 820 to the wireless terminal device 810, and as a result, the position estimation system 1 is capable of estimating the position of the wireless terminal device 810, even when the radio wave sensor devices 100 are unable to directly receive the wireless signals transmitted by the wireless terminal device 810.

If the base station device 820 does not transmit a beacon (see sequence S11) or the wireless terminal device 810 could not receive a beacon, the wireless terminal device 810 broadcasts a probe request (see sequence S12). When the base station device 820 receives the probe request, it transmits a probe response (see sequence S13) to the wireless terminal device 810, which is the transmission source of the probe request.

In this case, when the base station device 820 receives a probe request, it transmits a probe response to the wireless terminal device 810, which is the transmission source of the probe request. The position estimation system 1 acquires all of the probe responses. As a result, the position estimation system 1 is capable of determining, with respect to each base station device 820, whether or not the base station device 820 has received a probe request. Therefore, the position estimation system 1 is capable of determining, for each base station device 820, whether or not the wireless terminal device 810 is located inside a reception possible area of the base station device 820.

The radio wave sensor device 100 receives the wireless signal transmitted by the base station device 820 to the wireless terminal device 810, and extracts from the received wireless signal the identification information of the transmission source base station device 820, and the identification information of the transmission destination wireless terminal device 810. The position estimation system 1 is capable of using the identification information to determine the identity of the wireless terminal device 810 and the identity of the base station device 820.

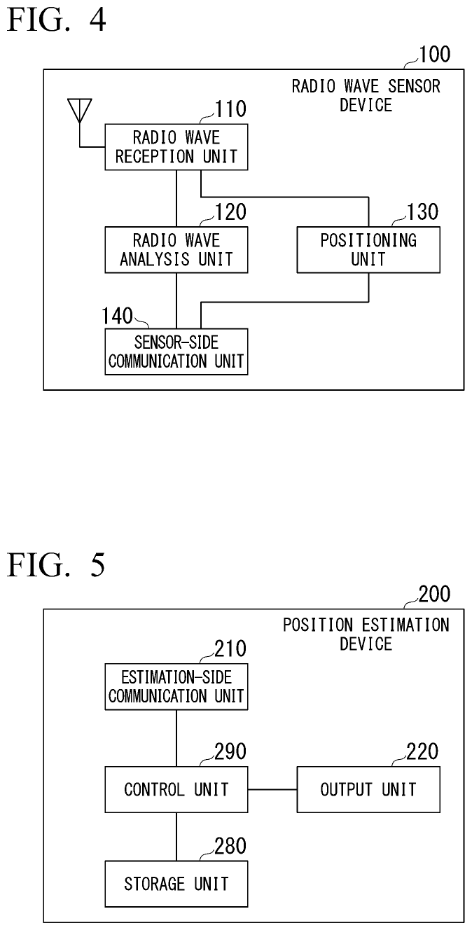

FIG. 4 is a schematic block diagram showing an example of a functional configuration of a radio wave sensor device 100. In the configuration shown in FIG. 4, the radio wave sensor device 100 includes a radio wave reception unit 110, a radio wave analysis unit 120, a positioning unit 130, and a sensor-side communication unit 140.

The radio wave radio wave reception unit 110 receives radio waves (radio signals). In particular, the radio wave reception unit 110 receives the wireless signals transmitted by the wireless terminal device 810, and the wireless signals transmitted by the base station device 820.

The radio wave analysis unit 120 analyzes the wireless signals received by the radio wave reception unit 110. Specifically, the radio wave analysis unit 120 acquires the type of wireless signal received by the radio wave reception unit 110 (a subtype such as “probe request” or “probe response”), the identification information of the transmission source, and the identification information of the transmission destination. Furthermore, the radio wave analysis unit 120 measures the radio wave reception strength (reception power) of the wireless signals. The information acquired by the radio wave analysis unit 120 (the type of wireless signal, the identification information of the transmission source, the identification information of the transmission destination, and the radio wave reception strength) is referred to as analysis result information.

The positioning unit 130 acquires position information of the radio wave sensor device 100, which includes the positioning unit 130 itself. The method by which the positioning unit 130 acquires the position information is not limited to a specific method. For example, the positioning unit 130 may include a GNSS (Global Navigation Satellite System) receiver, and perform the positioning using signals from a positioning satellite. The method by which the position information is acquired is not limited to such an example.

The radio wave sensor device 100 does not have to include the positioning unit 130 if the position estimation device 200 uses position information of the radio wave sensor device 100 stored in advance in a sensor information storage unit described later.

The sensor-side communication unit 140 communicates with the position estimation device 200 via the communication network 300. Specifically, the sensor-side communication unit 140 transmits to the position estimation device 200, the analysis result information acquired as a result of the radio wave analysis unit 120 analyzing the wireless signals received by the radio wave reception unit 110. Furthermore, the sensor-side communication unit 140 transmits to the position estimation device 200, the position information of the radio wave sensor device 100 obtained as a result of the positioning performed by the positioning unit 130.

The communication network 300 relays the communication between the radio wave sensor device 100 and the position estimation device 200. The communication network 300 is not limited to a specific type of communication network. Moreover, the communication network 300 may be constituted as equipment outside the position estimation system 1. For example, the Internet may be used as the communication network 300, or a LAN (Local Area Network) may be used. Alternatively, the communication network 300 may be configured as a signal line dedicated to the position estimation system 1.

The position estimation device 200 estimates the position of the wireless terminal device 810 using information from the radio wave sensor device 100.

The position estimation device 200 is configured by using a computer such as a personal computer (PC) or a workstation.

FIG. 5 is a schematic block diagram showing an example of a functional configuration of the position estimation device 200. In the configuration shown in FIG. 5, the position estimation device 200 includes an estimation-side communication unit (communication unit) 210, an output unit 220, a storage unit 280, and a control unit 290.

The estimation-side communication unit 210 communicates with the sensor-side communication unit 140 via the communication network 300. Specifically, the estimation-side communication unit 210 receives the information transmitted by the sensor-side communication unit 140.

The output unit 220 outputs various information. Specifically, the output unit 220 outputs the result of position estimation of the wireless terminal device 810. The output unit 220 may, for example, include a display screen such as a liquid crystal panel or an LED (Light Emitting Diode), and display the result of position estimation of the wireless terminal device 810. As another example, the position estimation device 200 may transmit (output) the result of position estimation of the wireless terminal device 810 to another device.

The storage unit 280 stores various information. The storage unit 280 is configured by using a storage device included in the position estimation device 200.

The control unit 290 performs various processing by controlling each unit of the position estimation device 200. The function of the control unit 290 can be executed as a result of a CPU (Central Processing Unit) included in the position estimation device 200 reading a program from the storage unit 280 and executing it.

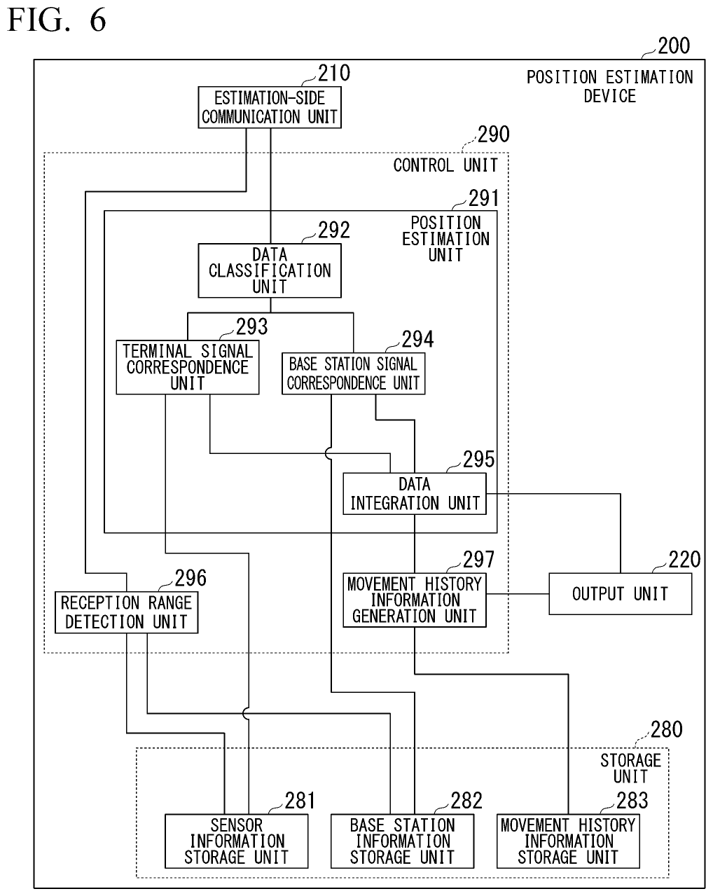

FIG. 6 is a functional block diagram showing in more detail, an example of a functional configuration of the position estimation device 200. In FIG. 6, a configuration example of the position estimation device 200 in FIG. 5 is shown. In FIG. 6, the configuration of the storage unit 280 and the configuration of the control unit 290 are shown in more detail.

In the configuration shown in FIG. 6, the storage unit 280 includes a sensor information storage unit 281, a base station information storage unit 282, and a movement history information storage unit 283. The control unit 290 includes a position estimation unit 291, a reception range detection unit 296, and a movement history information generation unit 297. The position estimation unit 291 includes a data classification unit 292, a terminal signal correspondence unit 293, a base station signal correspondence unit 294, and a data integration unit 295.

The sensor information storage unit 281 stores, for each radio wave sensor device 100, the identification information of the radio wave sensor device 100, the position information of the radio wave sensor device 100, and the radio wave reception range information of the radio wave sensor device 100. The radio wave reception range information of the radio wave sensor device 100 is information that indicates the range of radio wave transmission positions of the wireless terminal device 810 in which a signal transmitted by the wireless terminal device 810 can be received by the radio wave sensor device 100.

Together with the radio wave reception strength, the position information of the radio wave sensor device 100 is used by the position estimation device 200 to estimate the position of the wireless terminal device 810. The radio wave reception strength is the strength of the transmission signal of the wireless terminal device 810 received by the radio wave sensor device 100. The radio wave reception range information of the radio wave sensor device 100 is used by the position estimation device 200, together with information relating to whether or not the radio wave sensor device 100 received the transmission signal of the wireless terminal device 810, to estimate the position of the wireless terminal device 810. If the position estimation device 200 performs only one of these two types of processing, the sensor information storage unit 281 does not have to store the information for the other type of processing.

The sensor information storage unit 281 does not have to store the position information of the radio wave sensor device 100 if the position estimation device 200 uses the position information obtained from positioning by the radio wave sensor device 100, as the position information of the radio wave sensor device 100.

The base station information storage unit 282 stores, for each base station device 820, the identification information of the base station device 820, and the radio wave reception range information of the base station device 820. The radio wave reception range information of the base station device 820 is information that indicates the range of radio wave transmission positions of the wireless terminal device 810 in which a signal transmitted by the wireless terminal device 810 can be received by the base station device 820.

The movement history information storage unit 283 stores history information of the position of the wireless terminal device 810 (time series information of the position of the wireless terminal device 810).

The position estimation unit 291 estimates the position of the wireless terminal device 810. If a plurality of wireless terminal devices 810 are subjected to position estimation at the same time, the position estimation unit 291 estimates the position of each wireless terminal device 810.

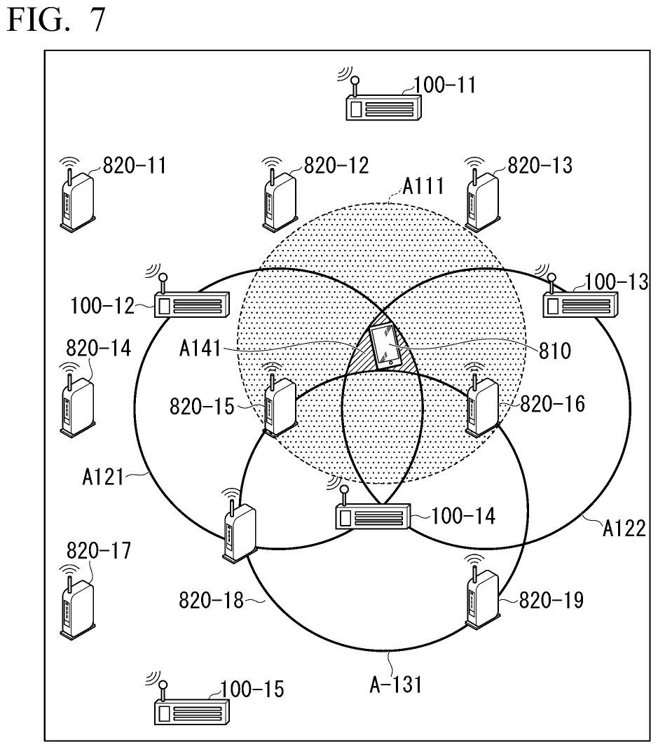

FIG. 7 shows a first example of position estimation of a wireless terminal device 810 by the position estimation device 200 (position estimation system 1). In FIG. 7, five radio wave sensor devices 100, one wireless terminal device 810, and nine base station devices 820 are shown. The five radio wave sensor devices 100 are designated by reference symbols 100-11 to 100-15 to distinguish between them. The nine base station devices 820 are designated by reference symbols 820-11 to 820-19 to distinguish between them.

The region A111 indicates the radio wave transmission range of the wireless terminal device 810. A signal from the wireless terminal device 810 reaches the radio wave sensor devices 100 and the base station devices 820 located inside the region A111. In the example of FIG. 7, the base station devices 820-15 and 820-16 are located inside the region A111. Therefore, the signal from the wireless terminal device 810 reaches the base station devices 820-15 and 820-16. The signal from the wireless terminal device 810 does not reach the other base station devices 820 and all of the radio wave sensor devices 100.

The region A121 indicates the radio wave reception range of the base station device 820-15. The region A122 indicates the radio wave reception range of the base station device 820-16. The region A131 indicates the radio wave reception range of the radio wave sensor device 100-14.

In this example, the base station devices 820-15 and 820-16 receive the signal from the wireless terminal device 810, and the reception sensor device 100-14 does not receive the signal from the wireless terminal device 810. As a result, the position estimation unit 291 of the position estimation device 200 estimates that the position of the wireless terminal device 810 is inside the region A141 (hatched portion), which lies inside the regions A121 and A122, and outside the region A131.

In the example of FIG. 7, of the base station devices 820-11 to 820-19, the base station devices 820-15, 820-16, 820-18 and 820-19 are located inside the region A131. Of the base station devices located inside the region A131, a response reaches the radio wave sensor device 100-14 from only the base station device 820-15 and the base station device 820-16, which received the signal from the wireless terminal device 810. The position estimation unit 291 installed in the position estimation device 200 detects, from the radio wave sensor device 100-14 via the communication network 300, that the base station device 820-15 and the base station device 820-16 transmitted a response. Therefore, the position estimation device 200 is capable of knowing that the wireless terminal device 810 is located inside the radio wave reception ranges of the base station devices 820-15 and 820-16. In this way, in the position estimation system 1, even when none of the radio wave sensor devices 200 are able to receive the signal from the wireless terminal device 810, the position of the wireless terminal device 810 can be estimated as a result of the radio wave sensor devices 200 receiving the response signals from the base station devices 820 that received the signal from the wireless terminal device 810.

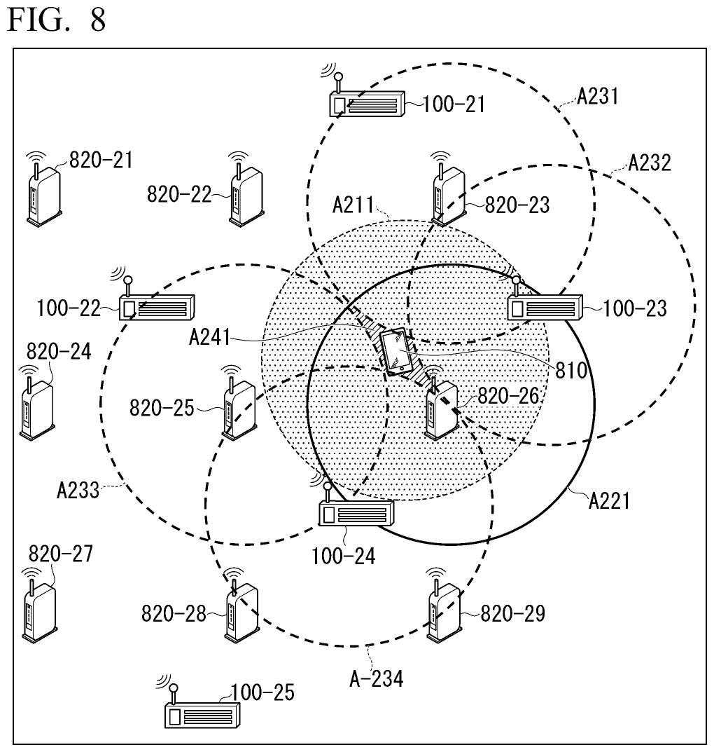

FIG. 8 is a diagram showing a second example of position estimation of a wireless terminal device 810 by the position estimation device 200 (position estimation system 1). In FIG. 8, five radio wave sensor devices 100, one wireless terminal device 810, and nine base station devices 820 are shown. The five radio wave sensor devices 100 are designated by reference symbols 100-21 to 100-25 to distinguish between them. The nine base station devices 820 are designated by reference symbols 820-21 to 820-29 to distinguish between them.

The region A211 indicates the radio wave transmission range of the wireless terminal device 810. A signal from the wireless terminal device 810 reaches the radio wave sensor devices 100 and the base station devices 820 located inside the region A211. In the example of FIG. 8, the base station device 820-26 is located inside the region A211. Therefore, the signal from the wireless terminal device 810 reaches the base station device 820-26. The signal from the wireless terminal device 810 does not reach the other base station devices 820 and all of the radio wave sensor devices 100.

The region A221 indicates the radio wave reception range of the base station device 820-26. The region A231 indicates the radio wave reception range of the base station device 820-23. The region A232 indicates the radio wave reception range of the radio wave sensor device 100-23. The region A233 indicates the radio wave reception range of the base station device 820-25. The region A234 indicates the radio wave reception range of the radio wave sensor device 100-24.

In this example, the base station device 820-26 receives the signal from the wireless terminal device 810. On the other hand, the base station devices 820-23 and 820-25 and the reception sensor device 100-24 do not receive the signal from the wireless terminal device 810. As a result, the position estimation unit 291 of the position estimation device 200 estimates that the position of the wireless terminal device 810 is inside the region A241 (hatched portion), which lies inside the region A221, and outside the regions A231, A232, A233, and A234.

It is assumed that the base station device 820-26 is located inside the region A232, and the response from the base station device 820-26 reaches the radio wave sensor device 100-23. The position estimation unit 291 of the position estimation device 200 detects, from the radio wave sensor device 100-23 via the communication network 300, that the base station device 820-26 transmitted a response. Therefore, the position estimation device 200 is capable of knowing that the wireless terminal device 810 is located inside the radio wave reception range of the base station device 820-26. In this way, in the example of FIG. 8 as well, none of the radio wave sensor devices 100 receive the signal from the wireless terminal device 820. However, the position of the wireless terminal device 810 can be estimated as a result of the radio wave sensor device 100 receiving the response signal from the base station device 820 that received the signal from the wireless terminal device 810.

The base station device 820-23 is located inside the region A232, which is the radio wave reception range of the radio wave sensor device 100-23. The base station device 820-25 is located inside the region A234, which is the radio wave reception range of the radio wave sensor device 100-24. The position estimation unit 291 is capable of determining that the radio wave sensor device 100-23 has not received a response signal (response) from the base station device 820-23, and that the radio wave sensor device 100-24 has not received a response signal from the base station device 820-25 in response to the broadcast of the request signal (request) from the wireless terminal device 810. Therefore, the position estimation unit 291 is capable of knowing that the base station devices 820-23 and 820-25 have not transmitted a response signal, and therefore, that the wireless terminal device 810 is located outside the radio wave reception ranges of the base station devices 820-23 and 820-25.

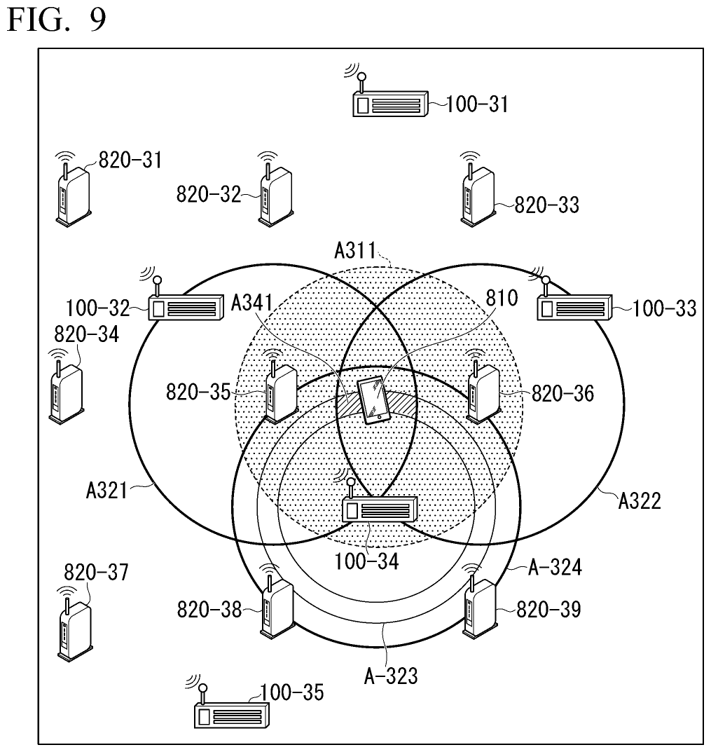

FIG. 9 shows a third example of position estimation of a wireless terminal device 810 by the position estimation device 200 (position estimation system 1). In FIG. 9, five radio wave sensor devices 100, one wireless terminal device 810, and nine base station devices 820 are shown. The five radio wave sensor devices 100 are designated by reference symbols 100-31 to 100-35 to distinguish between them. The nine base station devices 820 are designated by reference symbols 820-31 to 820-39 to distinguish between them.

The region A311 indicates the radio wave transmission range of the wireless terminal device 810. A signal from the wireless terminal device 810 reaches the radio wave sensor devices 100 and the base station devices 820 located inside the region A311. In the example of FIG. 9, the radio wave sensor device 100-34, and the base station devices 820-35 and 820-36 are located inside the region A311. Therefore, the signal from the wireless terminal device 810 reaches these radio wave sensor devices 100 and base station devices 820. The signal from the wireless terminal device 810 does not reach the other radio wave sensor devices 100 and base station devices 820.

The region A321 indicates the radio wave reception range of the base station device 820-35. The region A322 indicates the radio wave reception range of the base station device 820-36. Furthermore, the third example differs from the first example and the second example in that the radio wave sensor device 100-34 receives the signal from the wireless terminal device 810. Therefore, the radio wave sensor device 100-34 is capable of acquiring information which indicates the radio wave reception strength of the signal. As a result, the position estimation unit 291 is capable of estimating that the position of the wireless terminal device 810 is inside the donut-shaped region A323.

In this example, the radio wave sensor device 100-34 and the base station devices 820-35 and 820-36 receive the signal from the wireless terminal device 810. As a result, the position estimation unit 291 of the position estimation device 200 estimates that the position of the wireless terminal device 810 is inside the region A341 (hatched portion), which lies inside the regions A321, A322 and A323.

The base station devices 820-35 and 820-36 are both located inside the radio wave reception range (region A324) of the radio wave sensor device 100-34. Both the response signal from the base station device 820-35 and the response signal from the base station device 820-36 reach the radio wave sensor device 100-34. The position estimation unit 291 inside the position estimation device 200 detects, from the radio wave sensor device 100-34 via the communication network 300, that both the base station devices 820-35 and 820-36 transmitted a response signal. Therefore, the position estimation device 200 is capable of knowing that the wireless terminal device 810 is located inside the radio wave reception range of the base station device 820-35 and inside the radio wave reception range of the base station device 820-36. In this way, in the example of FIG. 9, because a radio wave sensor device 100 has received the signal from the wireless terminal device 810, it is capable of acquiring information relating to the strength of the signal. As a result, the position estimation device 200 is capable of further narrowing the estimated position of the wireless terminal device.

The data classification unit 292 classifies the analysis result information transmitted by the radio wave sensor device 100 according to whether the transmission source of the wireless signal subjected to analysis is the wireless terminal device 810 or a base station device 820. For example, if the type of wireless signal included in the analysis result information is a probe request, the data classification unit 292 classifies the transmission source of the wireless signal as the wireless terminal device 810. If the type of wireless signal included in the analysis result information is a probe response, the data classification unit 292 classifies the transmission source of the wireless signal as a base station device 820.

If the data classification unit 292 classifies the transmission source of the wireless signal as the wireless terminal device 810, it outputs the analysis result information to the terminal signal correspondence unit 293. Furthermore, if the data classification unit 292 classifies the transmission source of the wireless signal as a base station device 820, it outputs the analysis result information to the base station signal correspondence unit 294.

The terminal signal correspondence unit 293 limits the estimated position of the wireless terminal device 810 on the basis of the reception status of the signal transmitted by the wireless terminal device 810 at the radio wave sensor devices 100.

If the identification information of the radio wave sensor devices 100 that received the signal transmitted by the wireless terminal device 810 is obtained, the terminal signal correspondence unit 293 limits the estimated position of the wireless terminal device 810 to the inside of the signal reception ranges of the radio wave sensor devices 100. Further, the terminal signal correspondence unit 293 excludes the signal reception ranges of the radio wave sensor devices 100 that did not receive the signal transmitted by the wireless terminal device 810 from the estimated position of the wireless terminal device 810.

A case will be described where, in addition to the identification information of a radio wave sensor device 100 that received the signal transmitted by the wireless terminal device 810, information relating to the radio wave reception strength at the radio wave sensor device 100 is obtained. In this case, the terminal signal correspondence unit 293 estimates the distance between the radio wave sensor device 100 and the wireless terminal device 810 on the basis of the radio wave reception strength. Further, the terminal signal correspondence unit 293 limits the estimated position of the wireless terminal device 810 to a region which is separated from the position of the radio wave sensor device 100 by an estimated distance (that is to say, a region which is based on positions which are separated by the estimated distance from the position of the radio wave sensor device 100). The terminal signal correspondence unit 293 performs processing that limits the position of the wireless terminal device 810 to a region which is the estimated distance from the position of the radio wave sensor device 100, rather than processing which limits the position of the wireless terminal device 810 to the inside of the signal reception range of the radio wave sensor device 100.

Further, the terminal signal correspondence unit 293 may estimate the position of the wireless terminal device 810 by a three-point positioning procedure. Specifically, if the signal transmitted by the wireless terminal device 810 is received by three or more radio wave sensor device 100, and the radio wave reception strength can be measured, the terminal signal correspondence unit 293 estimates the position of the wireless terminal device 810 on the basis of the positions of the radio wave sensor devices 100 and the estimated distances from the radio wave sensor devices 100.

In this case, in addition to position estimation of the wireless terminal device 810 by the three-point positioning procedure, the position estimation unit 291 may perform position estimation of the wireless terminal device 810 on the basis of the signal reception ranges of the radio wave sensor devices 100 and the signal reception ranges of the base station devices 820 to confirm the reliability of the estimated position. If the estimated position of the wireless terminal device 810 from the three-point positioning procedure is inside the estimated position range of the wireless terminal device 810 obtained on the basis of the signal reception ranges of the radio wave sensor devices 100 and the signal reception ranges of the base station devices 820, the position estimation unit 291 determines that the reliability of the estimated position is high.

In this way, the terminal signal correspondence unit 293 estimates the position of the wireless terminal device 810 on the basis of the reception status of the signal from the wireless terminal device 810 at the radio wave sensor devices 100. The reception status of the signal described here refers to the presence or absence of signal reception at each radio wave sensor device 100, and further, is the reception strength (radio wave reception strength) of the signal.

When the reception status of the signal is the radio wave reception strength, the terminal signal correspondence unit 293 estimates the position of the wireless terminal device 810 on the basis of the radio wave reception strength of the signal from the wireless terminal device 810 received by the radio wave sensor devices 100, and the position information of the radio wave sensor devices 100.

The terminal signal correspondence unit 293 may estimate the position of the wireless terminal device 810 using the position information of the radio wave sensor devices 100 stored by the sensor information storage unit 281. The terminal signal correspondence unit 293 may estimate the position of the wireless terminal device 810 using the position information obtained as a result of the positioning performed by the positioning unit 130 of the radio wave sensor devices 100.

The base station signal correspondence unit 294 limits the estimated position of the wireless terminal device 810 on the basis of the signal reception ranges of the base station devices 820.

If a radio wave sensor device 100 receives a response signal transmitted by a base station device 820 in response to the signal from the wireless terminal device 810, the radio wave sensor device 100 generates analysis result information on the basis of the received signal, and transmits it to the position estimation device 200.

In the position estimation device 200, the base station signal correspondence unit 294 limits the estimated position of the wireless terminal device 810 to inside the signal reception ranges of the base station devices 820 indicated in the analysis result information as having received the radio wave from the wireless terminal device 810. The base station devices 820 indicated in the analysis result information as having received the radio wave from the wireless terminal device 810 are the base station devices 820 whose identification information is indicated as a transmission source of a response signal in the analysis result information.

If a request signal is broadcast from the wireless terminal device 810, the base station signal correspondence unit 294 excludes, from the estimated position of the wireless terminal device 810, the signal reception ranges of the base station devices 820 not indicated in the analysis result information as having received the radio wave from the wireless terminal device 810 according to the analysis result information. The base station devices 820 not indicated in the analysis result information as having received the radio wave from the wireless terminal device 810 according to the analysis result information are the base station devices 820 whose identification information is not shown as a transmission source of a response signal.

It can be determined on the basis of the destination of the request signal whether the request signal from the wireless terminal device 810 is a broadcast or a unicast. For example, in the case of Wi-Fi (registered trademark), a MAC address of the destination is listed in the probe request signal. If the value of the MAC address is the hexadecimal number “FFFFFFFFFFFF”, the control unit 290 (for example, the terminal signal correspondence unit 293) determines that the request signal from the wireless terminal device 810 is a broadcast. On the other hand, if the value of the MAC address is a hexadecimal number other than “FFFFFFFFFFFF”, the control unit 290 (for example, the terminal signal correspondence unit 293) determines that the request signal from the wireless terminal device 810 is a unicast.

Alternatively, it can be determined by the number of base station devices 820 transmitting a response signal whether the request signal from the wireless terminal device 810 is a broadcast or a unicast. If a plurality of base station devices 820 transmit a response signal in response to a single request signal, the control unit 290 (for example, the base station signal correspondence unit 294) determines that the request signal from the wireless terminal device 810 was a broadcast. If only one base station device 820 transmits a response signal in response to a single request signal, the control unit 290 (for example, the base station signal correspondence unit 294) determines that there is a high probability that the request signal from the wireless terminal device 810 was a unicast.

In this way, the base station signal correspondence unit 294 estimates the position of the wireless terminal device 810 on the basis of the radio wave reception ranges of the base station devices 820 transmitting a response signal in response to the signal from the wireless terminal device 810. Specifically, the base station signal correspondence unit 294 estimates the position of the wireless terminal device 810 on the basis of the reception status of the response signal at the radio wave sensor devices 100. The reception status of the response signal described here refers to the presence or absence of reception of the response signal at the radio wave sensor devices 100. The base station signal correspondence unit 294 limits to the radio wave reception ranges of the base station devices 820 transmitting a response signal in response to the signal from the wireless terminal device 810. Further, the base station signal correspondence unit 294 excludes the radio wave reception ranges of the base station devices 820 that did not transmit a response signal in response to the signal from the wireless terminal device 810, from the estimated position of the wireless terminal device 810.

The data integration unit 295 integrates the estimated position of the wireless terminal device 810 according to the terminal signal correspondence unit 293 and the estimated position of the wireless terminal device 810 according to the base station signal correspondence unit 294. Specifically, the data integration unit 295 specifies an AND (overlapping section) between the estimated position of the wireless terminal device 810 according to the terminal signal correspondence unit 293 and the estimated position of the wireless terminal device 810 according to the base station signal correspondence unit 294. The estimated position obtained as a result of the integration by the data integration unit 295 is used as the estimation result of the wireless terminal device 810 according to the position estimation device 200.

The movement history information generation unit 297 generates movement history information of the wireless terminal device 810 on the basis of the position information of the wireless terminal device 810. The movement history information of the wireless terminal device 810 referred to here is time series information of the estimated position of the wireless terminal device 810. When a plurality of wireless terminal devices 810 are subjected to position estimation at the same time, the movement history information generation unit 297 generates movement history information for each wireless terminal device 810. The movement history information generation unit 297 stores the movement history information in the movement history information storage unit 283 and updates it.

A wireless transmission device (not shown) capable of transmitting a request signal to the base station devices 820 is used to detect the radio wave reception ranges of the base station devices 820. If the wireless transmission device transmits a request signal to a base station device 820 and the base station device 820 transmits a response signal, the position of the wireless transmission device is inside the radio wave reception range of the base station device 820. If the request destination base station device 820 does not transmit a response signal, the position of the wireless transmission device is outside the radio wave reception range of the base station device 820.

The wireless transmission device may transmit the request signal by a broadcast, or may transmit the request signal by a unicast.

In the position estimation device 200, the reception range detection unit 296 detects the radio wave reception ranges of the base station devices 820.

For example, the wireless transmission device transmits the position information of the wireless transmission device itself in addition to the request signal. The radio wave sensor devices 100 receive the request signal and the position information transmitted by the wireless transmission device, and transmit to the position estimation device 200 the identification information of the wireless transmission device, the identification information of the transmission destination base station device 820 (and if applicable, information indicating it is a broadcast), and the position information of the wireless transmission device. Furthermore, when a base station device 820 transmits a response signal and a radio wave sensor device 100 receives the signal, the radio wave sensor device 100 transmits to the position estimation device 200, the identification information of the transmission source base station device 820, and the identification information of the transmission destination wireless transmission device.

The reception range detection unit 296 of the position estimation device 200 calculates the distance between the wireless transmission device, which is the request signal transmission source, and the base station device 820, which is the transmission destination of the request signal. If the base station device 820 serving as the transmission destination of the request signal transmits a response signal, the reception range detection unit 296 detects the region centered on the base station device 820 and within the distance from the base station device 820 to the wireless transmission device as being inside the radio wave reception range of the base station device 820. On the other hand, if the base station device 820 serving as the transmission destination of the request signal does not transmit a response signal, the reception range detection unit 296 detects the region centered on the base station device 820 and beyond the distance from the base station device 820 to the wireless transmission device as being outside the radio wave reception range of the base station device 820.

In this way, the reception range detection unit 296 detects the radio wave reception range of a base station device 820 on the basis of a reception status relating to reception by the base station device 820 of a radio wave from the wireless transmission device, and the position information of the wireless transmission device. The base station devices 820 may also detect the radio wave reception ranges of the radio wave sensor devices 100 in the same manner.

When the reception range detection unit 296 detects the radio wave reception ranges of the base station devices 820, the radio wave sensor devices 100 may be used as wireless transmission devices.

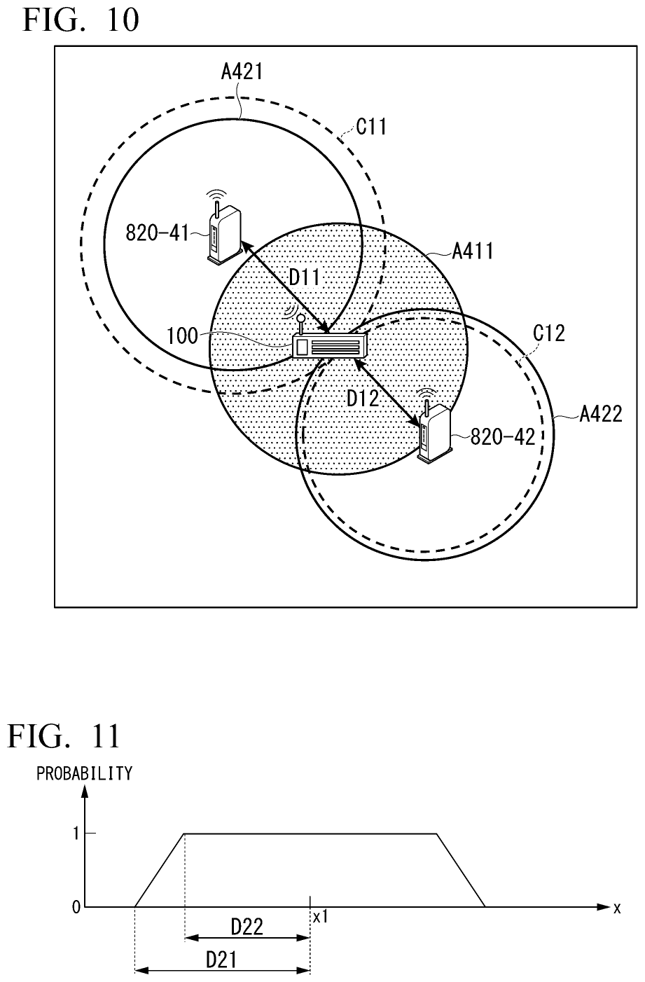

FIG. 10 shows an example of detection of the radio wave reception ranges of base station devices 820 by the reception range detection unit 296. In FIG. 10, an example is shown in which the reception range detection unit 296 detects the radio wave reception ranges of base station devices 820 using a radio wave sensor device 100 as a wireless transmission device.

In FIG. 10, one radio wave sensor device 100 and two base station devices 820 are shown. The two base station devices 820 are designated by reference symbols 820-41 and 820-42 to distinguish between them.

The region A411 indicates the radio wave transmission range of the radio wave sensor device 100. A signal (request signal) from the radio wave sensor device 100 reaches the base station devices 820 located inside the region A411. In the example of FIG. 10, the base station device 820-42 is located inside the region A411, and thus, the signal from the radio wave sensor device 100 reaches the base station device 820-42. On the other hand, the base station device 820-41 is located outside the region A411, and thus, the signal from the radio wave sensor device 100 does not reach the base station device 820-41.

If the radio wave sensor device 100 broadcasts the request signal, the radio wave sensor device 100 receives a response signal from the base station device 820-42, but does not receive a response signal from the base station device 820-41. The reception range detection unit 296 is capable of knowing, on the basis of the information from the radio wave sensor device 100, that the radio wave sensor device 100 is located inside the radio wave reception range of the base station device 820-42, and that the radio wave sensor device 100 is located outside the radio wave reception range of the base station device 820-41.

The distance D11 is the distance between the base station device 820-41 and the radio wave sensor device 100. The circle C11 is a circle centered on the position of the base station device 820-41 and having the distance D11 as the radius. The reception range detection unit 296 determines that the radio wave reception range of the base station device 820-41 is located inside the circle C11.

The distance D12 is the distance between the base station device 820-42 and the radio wave sensor device 100. The circle C12 is a circle centered on the position of the base station device 820-42 and having the distance D12 as the radius. The reception range detection unit 296 determines that the radio wave reception range of the base station device 820-42 includes the circle C12, and the inside thereof.

In this way, the reception range detection unit 296 is capable of limiting (detecting) the radio wave reception ranges of the base station devices 820 using a radio wave sensor device 100 which is fixedly installed. As a result of a plurality of radio wave sensor devices 100 at different distances from a base station device 820 functioning as wireless transmission devices, it is possible to detect whether or not each of the plurality of distances from the base station device 820 is inside the radio wave reception range of the base station device 820.

If the radio wave transmission range and the radio wave reception range of a radio wave sensor device 100 can be regarded as the same, the reception range detection unit 296 can also detect the radio wave reception range of a radio wave sensor device 100 from the detection of the radio wave reception range of a base station device 820, which uses the radio wave sensor device 100 as a wireless transmission device. In the example of FIG. 10, the reception range detection unit 296 determines that the radio wave reception range of the radio wave sensor device 100 is located further inside than a circle centered at the position of the radio wave sensor device 100 and having a radius of distance D11, and includes a circle centered at the position of the radio wave sensor device 100 and related to distance D12, and the inside thereof.

If the reception range detection unit 296 is unable to uniquely specify the radio wave reception range of a base station device 820, the radio wave reception range may be detected as a range having a probability gradient.

FIG. 11 is a diagram showing an example of a radio wave reception range having a probability gradient. The horizontal axis of the graph of FIG. 11 represents the x axis of the horizontal xy plane. The vertical axis represents the probability.

The coordinate x1 represents the x coordinate of the position of the base station device 820.

FIG. 11 shows an example of a case where the reception range detection unit 296 determines that the radio wave reception range of a base station device 820 is located inside a circle centered at the position of the base station device 820 (x1) and having a radius of distance D21, and includes a circle centered at the position of the base station device 820 (x1) and having a radius of distance D22, and the inside thereof. In this case, the reception range detection unit 296 sets the probability that the radio wave reception range of the base station device 820 is located outside the region of the circle centered at the position of the base station device 820 and having a radius of distance D21 as 0 (0%), and the probability that the radio wave reception range includes the region of the circle centered at the position of the base station device 820 and having a radius of distance D22, and the inside thereof, as 1 (100%). Further, as shown in FIG. 11, the probability that the radio wave reception range of the base station device 820 is included in the range equal to or more than distance D22 and equal to or less than the distance D21 from the position of the base station device 820 is set to a probability having a gradient from 0 (0%) to 1 (100%).

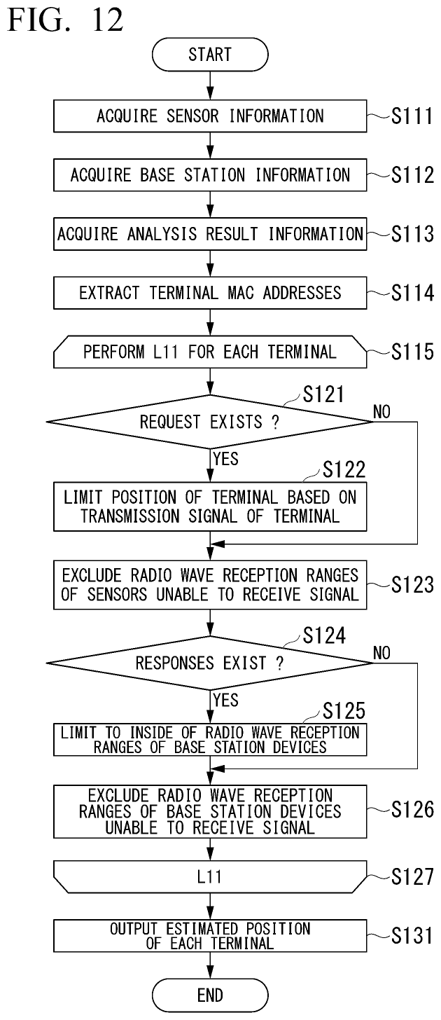

Next, the operation of the position estimation device 200 will be described with reference to FIG. 12.

FIG. 12 is a flowchart showing an example of a processing procedure by which the position estimation device 200 estimates the positions of wireless terminal devices 810. For example, when the estimation-side communication unit 210 receives a signal from a radio wave sensor device 100, the position estimation device 200 starts the processing of FIG. 12.

In the processing of FIG. 12, the position estimation unit 291 acquires the sensor information of each radio wave sensor device 100 (step S111). The position estimation unit 291 specifically acquires the identification information, the position information (installation positions of the radio wave sensor devices 100), and the radio wave reception range information of the radio wave sensor devices 100.

Next, the position estimation unit 291 acquires the base station information of each base station device 820 (step S112). The position estimation unit 291 specifically acquires the identification information and the radio wave reception range information of the base station devices 820.

Then, the position estimation unit 291 acquires the analysis result information from the radio wave sensor devices 100 (step S113).

The position estimation unit 291 extracts the MAC addresses of the wireless terminal devices 810 from the obtained analysis result information (step S114).

Further, the position estimation unit 291 starts loop L11, which performs processing for each wireless terminal device 810 (for each of the MAC addresses of the wireless terminal devices 810 extracted in step S114) (step S115). The wireless terminal device 810 subjected to processing in loop L11 is referred to as a target terminal. In the processing of loop L11, the position estimation unit 291 determines whether or not analysis result information indicating a request (request signal) transmitted by the target terminal exists (step S121).

If it is determined that analysis result information indicating a request transmitted by the target terminal exists (step S121: YES), the terminal signal correspondence unit 293 of the position estimation unit 291 limits the estimated position of the target terminal on the basis of the transmitted signal (request signal) of the target terminal (step S122). The request signal in this case is received by the radio wave sensor devices 100. If the radio wave reception strength information of the target terminal is obtained from the radio wave sensor devices 100, the terminal signal correspondence unit 293 estimates the distances between the radio wave sensor devices 100 and the target terminal. On the other hand, if information indicating reception of the radio wave is obtained from the radio wave sensor devices 100, but radio wave reception strength information is not obtained, the terminal signal correspondence unit 293 limits the estimated position of the target terminal to the inside of the radio wave reception ranges of the radio wave sensor devices 100.

Furthermore, the terminal signal correspondence unit 293 limits the estimated position of the target terminal to the outside of the radio wave reception ranges of the radio wave sensor devices 100 that could not receive the request signal (step S123).

Furthermore, the position estimation unit 291 determines whether or not analysis result information indicating responses (response signals) addressed to the target terminal exists (step S124).

If it is determined that analysis result information indicating responses addressed to the target terminal exists (step S124: YES), the base station signal correspondence unit 294 of the position estimation unit 291 limits the estimated position of the target terminal to the inside of the radio wave reception ranges of the response transmission source base station devices 820 (step S125).

Furthermore, the base station signal correspondence unit 294 limits the estimated position of the target terminal to the outside of the radio wave reception ranges of the base station devices 820 that did not transmit a response (step S126).

After step S126, the position estimation unit 291 performs termination processing of loop L11 (step S127). Specifically, the position estimation unit 291 determines whether or not the processing of loop L11 has been completed for all of the wireless terminal devices 810 whose MAC addresses were obtained in step S114. If it is determined that there are unprocessed wireless terminal devices 810, the processing returns to step S115, and the position estimation unit 291 continues to perform the processing of loop L11 for the unprocessed wireless terminal devices 810. On the other hand, if it is determined that the processing of loop L11 has been completed for all of the wireless terminal devices 810, the position estimation unit 291 terminates loop L11.

When loop L11 is terminated, the position estimation unit 291 controls the output unit 220 and cause it to output the estimated position of each wireless terminal device 810 (step S131).

After step S131, the position estimation device 200 terminates the processing of FIG. 12.

On the other hand, if the position estimation unit 291 determines in step S121 that there is no analysis result information indicating a request signal transmitted by the target terminal (step S121: NO), the processing proceeds to step S123.

If the position estimation unit 291 determines in step S124 that there is no analysis result information indicating responses addressed to the target terminal (step S124: NO), the processing proceeds to step S126.

As described above, the position estimation unit 291 estimates the position of the wireless terminal device 810 on the basis of not only the radio wave reception ranges of the radio wave sensor devices 100 that received the signal from the wireless terminal device 810, but also the radio wave reception ranges of the base station devices 820 transmitting a response signal in response to the signal from the wireless terminal device 810.

The position estimation unit 291 estimates the position of the wireless terminal device 810 on the basis of the response signals of the base station devices 820 in response to the signal from the wireless terminal device 810, and thus, the position of the wireless terminal device 810 can be estimated without the need for the position estimation system 1 to transmit a request signal to the base station devices 820. Therefore, the position estimation unit 291 is capable of estimating the position of the wireless terminal device 810 by using information from base station devices 820 with which direct communication by the position estimation system 1 is not possible.

Furthermore, the position estimation unit 291 estimates the position of the wireless terminal device 810 on the basis of the radio wave reception ranges of the base station devices 820 transmitting a response signal in response to the signal from the wireless terminal device 810, and also the radio wave reception ranges of the base station devices 820 that did not transmit a response signal in response to the signal from the wireless terminal device 810.

As a result, the position estimation unit 291 is capable of estimating the position of the wireless terminal device 810 by further limiting the range than for a case where the position of the wireless terminal device 810 is estimated on the basis of only the radio wave reception ranges of the base station devices 820 transmitting a response signal in response to the signal from the wireless terminal device 810.

Furthermore, the position estimation unit 291 estimates the position of the wireless terminal device 810 on the basis of the reception status of the response signal at the radio wave sensor devices 100.

As a result, in the position estimation system 1, the signals (response signals) from the base station devices 820 can be received by the radio wave sensor devices 100 over a wide range by adjusting the number and arrangement of the radio wave sensor devices 100. In the position estimation system 1, by acquiring signals from the base station devices 820 over a wide area, position estimation of the wireless terminal device 810 can be performed over a wide area.

Furthermore, in the position estimation system 1, a communication connection is not necessary between the position estimation device 200 and the base station devices 820. In this respect, the installation of the position estimation system 1 has a high degree of freedom and is relatively easy. Moreover, the position estimation unit 291 is capable of estimating the position of the wireless terminal device 810 by using information from base station devices 820 with which direct communication by the position estimation system 1 is not possible. In addition, in the position estimation system 1, even if the radio wave sensor devices 100 are unable to directly receive a signal from the wireless terminal device 810, it is possible to estimate the position of the wireless terminal device 810 on the basis of the received information at the base station devices 820. Also, in the position estimation system 1, when existing base station devices are used as the base station devices 820, it is possible to reduce the number of installed radio wave sensor devices 100 and to reduce installation costs by diverting information which indicates whether or not a signal from the wireless terminal device 810 has been received by these base station devices.

In addition, the position estimation unit 291 further estimates the position of the wireless terminal device 810 on the basis of the reception status of the signal from the wireless terminal device 810 at the radio wave sensor devices 100.

As a result, the position estimation unit 291 is capable of estimating the position of the wireless terminal device 810 more precisely than in a case where the position of the wireless terminal device 810 is estimated on the basis of only the radio wave reception ranges of the base station devices 820.

Furthermore, the position estimation unit 291 estimates the position of the wireless terminal device 810 on the basis of the radio wave reception strength of the signal received by the radio wave sensor devices 100 from the wireless terminal device 810, and the position information of the radio wave sensor devices 100.

In this way, the position estimation unit 291 estimates the position of the wireless terminal device 810 on the basis of the radio wave reception strength of the radio wave sensor devices 100, and thus, the position of the wireless terminal device 810 can be estimated more precisely than in a case where the area of the estimated position of the wireless terminal device 810 is limited on the basis of the radio wave reception range of the radio wave sensor device 100.

Furthermore, the position estimation unit 291 may estimate the position of the wireless terminal device 810 using the position information of the radio wave sensor devices 100 stored by the sensor information storage unit 281.

In this case, it is not necessary for the radio wave sensor devices 100 to determine the position of the radio wave sensor device 100 themselves. In this respect, the configuration of the radio wave sensor device 100 can be simplified.

Furthermore, the position estimation unit 291 may estimate the position of the wireless terminal device 810 using the position information obtained as a result of the positioning performed by the radio wave sensor devices 100 themselves.

In this case, the user of the position estimation system 1 does not need to register the position information of the radio wave sensor devices 100 in the position estimation device 200 in advance. In this respect, the burden on the user can be reduced.

Furthermore, the movement history information generation unit 297 generates movement history information of the wireless terminal device 810 on the basis of the position information of the wireless terminal device 810.

As a result, the user of the position estimation system 1 is capable of recognizing the position of the wireless terminal device 810 as a time series, which can be useful for tracking the position of the wireless terminal device 810.

Furthermore, the reception range detection unit 296 detects the radio wave reception ranges of the base station devices 820 on the basis of the reception status relating to reception by the base station devices 820 of the radio wave from the wireless transmission device, and the position information of the wireless transmission device.

As a result, the user of the position estimation system 1 does not need to register the radio wave reception range information of the base station devices 820 in the position estimation device 200 in advance. In this respect, the burden on the user can be reduced.

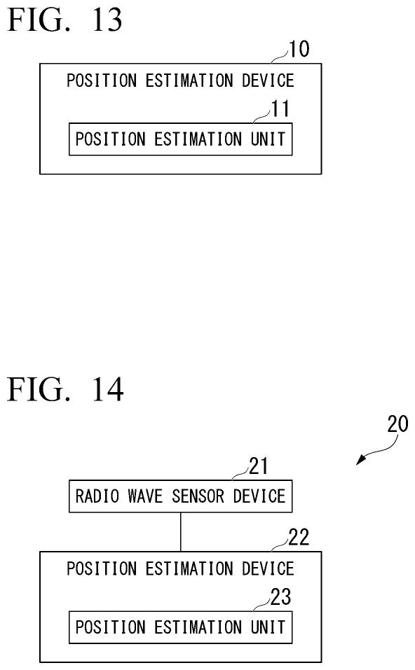

Next, a configuration of an example embodiment of the present invention will be described with reference to FIGS. 13 and 14.

FIG. 13 is a diagram showing an example of a configuration of a position estimation device 10 according to an example embodiment. The position estimation device 10 shown in FIG. 13 includes a position estimation unit 11.

According to this configuration, the position estimation unit 11 estimates the position of a wireless terminal device on the basis of a radio wave reception range of a base station device transmitting a response signal in response to a signal from the wireless terminal device.

In this way, the position estimation unit 11 estimates the position of the wireless terminal device on the basis of the response signal of the base station device in response to the signal from the wireless terminal device, and as a result, the position of the wireless terminal device can be estimated without the need for the position estimation device 10 to transmit a request signal to the base station device. Therefore, the position estimation unit 11 is capable of estimating the position of the wireless terminal device by using information from a base station device with which direct communication by the position estimation device 10 is not possible.

FIG. 14 shows an example of a configuration of a position estimation system according to an example embodiment. The position estimation system 20 shown in FIG. 14 includes a radio wave sensor device 21 and a position estimation device 22. The position estimation device 22 includes a position estimation unit 23.

According to this configuration, the radio wave sensor device 21 notifies the position estimation device 22 of the reception status at the radio wave sensor device 21 itself, of the response signal transmitted when the base station device receives the signal from the wireless terminal device. In the position estimation device 22, the position estimation unit 23 estimates the position of the wireless terminal device on the basis of the reception status of the response signal at the radio wave sensor device 21, and the radio wave reception range of the base station device.

In this way, the position estimation unit 23 estimates the position of the wireless terminal device on the basis of the response signal of the base station device in response to the signal from the wireless terminal device, and as a result, the position of the wireless terminal device can be estimated without the need for the position estimation system 20 to transmit a request signal to the base station device. Therefore, the position estimation unit 23 is capable of estimating the position of the wireless terminal device by using information from a base station device with which direct communication by the position estimation system 20 is not possible.

A program for executing some or all of the processing performed by the control unit 290 may be recorded in a computer-readable recording medium, and the processing of each unit may be performed by a computer system reading and executing the program recorded on the recording medium. The “computer system” referred to here is assumed to include an OS and hardware such as a peripheral device.

Furthermore, the “computer-readable recording medium” refers to a portable medium such as a flexible disk, a magnetic optical disk, a ROM, or a CD-ROM, or a storage device such as a hard disk built into a computer system. Moreover, the program may be one capable of realizing some of the functions described above, and it may be one capable of realizing the functions described above in combination with a program already recorded in the computer system.

Example embodiments of the present invention has been described in detail above with reference to the drawings. However, specific configurations are in no way limited to the example embodiments, and include designs and the like within a scope not departing from the spirit of the present invention.

A part or all of the example embodiment described above can be written as in the supplementary notes below, but is not limited thereto.

(Supplementary Note 1)

A position estimation device comprising:
a position estimation unit that estimates a position of a wireless terminal device based on a radio wave reception range of the base station device that has transmitted a response signal in response to a signal from the wireless terminal device.

(Supplementary Note 2)

The position estimation device according to supplementary note 1, wherein the position estimation unit further estimates the position of the wireless terminal device based on a radio wave reception range of a base station device that has not transmitted a response signal in response to the signal from the wireless terminal device.

(Supplementary Note 3)

The position estimation device according to supplementary note 1 or 2, further comprising
a communication unit that communicates with a radio wave sensor device,
wherein the position estimation unit further estimates the position of the wireless terminal device based on a reception status of the response signal at the radio wave sensor device.

(Supplementary Note 4)

The position estimation device according to supplementary note 3, wherein the position estimation unit further estimates the position of the wireless terminal device based on a reception status of the signal from the wireless terminal device at the radio wave sensor device.

(Supplementary Note 5)

The position estimation device according to supplementary note 3, wherein the position estimation unit further estimates the position of the wireless terminal device based on a radio wave reception strength of the response signal, and position information of the radio wave sensor device.

(Supplementary Note 6)

The position estimation device according to supplementary note 5, further comprising
a sensor information storage unit that stores position information of the radio wave sensor device.

(Supplementary Note 7)

The position estimation device according to supplementary note 5 or 6, wherein the radio wave sensor device obtains the position information by measuring a position of the radio wave sensor device.

(Supplementary Note 8)

The position estimation device according to any one of supplementary notes 1 to 7, further comprising
a movement history information generation unit that generates movement history information of the wireless terminal device based on the estimated position of the wireless terminal device.

(Supplementary Note 9)

9. The position estimation device according to any one of supplementary notes 1 to 8, further comprising
a reception range detection unit that detects a radio wave reception range of the base station device based on a reception status relating to reception by the base station device of a radio wave transmitted from a wireless transmission device, and position information of the wireless transmission device.

(Supplementary Note 10)

A position estimation system comprising a radio wave sensor device and a position estimation device, wherein
the radio wave sensor device notifies the position estimation device of a reception status relating to reception by the radio wave sensor device, of a response signal transmitted by a base station device in response to reception of a signal from a wireless terminal device, and
the position estimation device comprises
a position estimation unit that estimates a position of the wireless terminal device based on the reception status and a radio wave reception range of the base station device.

(Supplementary Note 11)

A position estimation method comprising:
estimating a position of a wireless terminal device based on a radio wave reception range of a base station device that has transmitted a response signal in response to a signal from the wireless terminal device.

(Supplementary Note 12)

A recording medium that stores a program for causing a computer to execute:
estimating a position of a wireless terminal device based on a radio wave reception range of a base station device that has transmitted a response signal in response to a signal from the wireless terminal device.

This application is based upon and claims the benefit of priority from Japanese patent application No. 2018-182338, filed Sep. 27, 2018, the disclosure of which is incorporated herein in its entirety by reference.

### INDUSTRIAL APPLICABILITY

The present invention may be applied to a position estimation device, a position estimation system, a position estimation method, and a recording medium.

### Reference Symbols

1, 20 Position estimation system

21, 100 Radio wave sensor device

10, 22, 200 Position estimation device

11, 23, 291 Position estimation unit

110 Radio wave reception unit

120 Radio wave analysis unit

130 Positioning unit

140 Sensor-side communication unit

210 Estimation-side communication unit

220 Output unit

280 Storage unit

281 Sensor information storage unit

282 Base station information storage unit

283 Movement history information storage unit

290 Control unit

292 Data classification unit

293 Terminal signal correspondence unit

294 Base station signal correspondence unit

295 Data integration unit

296 Reception range detection unit

297 Movement history information generation unit

300 Communication network

810 Wireless terminal device

820 Base station device

What is claimed is:

1. A position estimation device comprising:
at least one memory configured to store instructions; and
at least one processor configured to execute the instructions to:
estimate a position of a wireless terminal device based on a radio wave reception range of the base station device that has transmitted a response signal in response to a signal from the wireless terminal device.

2. The position estimation device according to claim 1, wherein the at least one processor is configured to execute the instructions to further estimate the position of the wireless terminal device based on a radio wave reception range of a base station device that has not transmitted a response signal in response to the signal from the wireless terminal device.

3. The position estimation device according to claim 1, further comprising
a communication interface that communicates with a radio wave sensor device,
wherein the at least one processor is configured to execute the instructions to further estimate the position of the wireless terminal device based on a reception status of the response signal at the radio wave sensor device.

4. The position estimation device according to claim 3, wherein the at least one processor is configured to execute the instructions to further estimate the position of the wireless terminal device based on a reception status of the signal from the wireless terminal device at the radio wave sensor device.

5. The position estimation device according to claim 3, wherein the at least one processor is configured to execute the instructions to further estimate the position of the wireless terminal device based on a radio wave reception strength of the response signal, and position information of the radio wave sensor device.

6. The position estimation device according to claim 5,
wherein the at least one memory includes a memory that stores position information of the radio wave sensor device.

7. The position estimation device according to claim 5, wherein the radio wave sensor device obtains the position information by measuring a position of the radio wave sensor device.

8. The position estimation device according to claim 1,
wherein the at least one processor is configured to execute the instructions to generate movement history information of the wireless terminal device based on the estimated position of the wireless terminal device.

9. The position estimation device according to claim 1,
wherein the at least one processor is configured to execute the instructions to detect a radio wave reception range of the base station device based on a reception status relating to reception by the base station device of a radio wave transmitted from a wireless transmission device, and position information of the wireless transmission device.

10. A position estimation system comprising a radio wave sensor device and a position estimation device, wherein
the radio wave sensor device comprises:
at least one memory configured to store first instructions; and
at least one processor configured to execute the first instructions to:
notify the position estimation device of a reception status relating to reception by the radio wave sensor device, of a response signal transmitted by a base station device in response to reception of a signal from a wireless terminal device, and
the position estimation device comprises:
at least one memory configured to store second instructions; and
at least one processor configured to execute the second instructions to:
estimate a position of the wireless terminal device based on the reception status and a radio wave reception range of the base station device.

11. A position estimation method comprising:
estimating a position of a wireless terminal device based on a radio wave reception range of a base station device that has transmitted a response signal in response to a signal from the wireless terminal device.

12. (canceled)
